(19) United States
(12) Patent Application Publication
(10) Pub. No.: US 2014/0062258 A1
(43) Pub. Date: Mar. 6, 2014

(54) EXTERNAL FORCE DETECTION EQUIPMENT AND EXTERNAL FORCE DETECTION SENSOR

(71) Applicant: NIHON DEMPA KOGYO CO., LTD., TOKYO (JP)

(72) Inventors: MITSUAKI KOYAMA, SAITAMA (JP); TAKERU MUTOH, SAITAMA (JP)

(73) Assignee: NIHON DEMPA KOGYO CO., LTD., TOKYO (JP)

(21) Appl. No.: 14/018,438

(22) Filed: Sep. 5, 2013

(30) Foreign Application Priority Data
Sep. 6, 2012 (JP) 2012-196458

(51) Int. Cl. G01L 1/16

(52) U.S. Cl. CPC G01L 1/162
USPC 310/323.21

(57) ABSTRACT

External force detection equipment according to the present disclosure includes a container, a supporting portion, one excitation electrode, another excitation electrode, an oscillation circuit, a movable electrode, a fixed electrode, a frequency information detecting unit, and a conductor. An oscillation loop is formed from the oscillation circuit to pass through the one excitation electrode, the other excitation electrode, the movable electrode, and the fixed electrode, and return to the oscillation circuit. The frequency information detected by the frequency information detecting unit is used for estimating an external force acting on the piezoelectric plate.

### CROSS-REFERENCE TO RELATED APPLICATION

This application claims the priority benefit of Japanese application Ser. No. 2012-196458, filed on Sep. 06, 2012. The entirety of the above-mentioned patent application is hereby incorporated by reference herein and made a part of this specification.

### BACKGROUND

1. Technical Field

The present disclosure relates to a technical field of detecting an external force such as acceleration, pressure, flow rate of a fluid, magnetic force, or electrostatic force by using a piezoelectric plate such as a crystal blank to detect the magnitude of the external force acting on the piezoelectric plate based on an oscillation frequency.

2. Description of the Related Art

External forces that act on a system include a force that acts on an object based on acceleration, pressure, flow rate, magnetic force, electrostatic force, and similar force, and there are many cases where these external forces need to be measured accurately. For example, during the development phase of an automobile, the impact force on the seats is measured when the automobile collides with an object. The acceleration and similar parameter of shaking is desired to be investigated as precisely as possible in order to investigate the vibrational energy and amplitude during an earthquake. Further, other exemplary measurements of external forces include the case where a flow rate of fluid or gas is accurately investigated and the detected values are reflected in a control system, the case where performance of a magnet is measured, and similar case. In carrying out these measurements, it is required that the measuring apparatus has a structure as simple as possible and takes a high accurate measurement.

Japanese Unexamined Patent Application No. 2006-138852 (see paragraphs [0021] and [0028]) discloses that a piezoelectric film is cantilevered and the piezoelectric film deforms due to a change in surrounding magnetic force, and this changes a current flowing in the piezoelectric film.

Further, other exemplary measurements of external forces include the case where a flow rate of fluid or gas is accurately investigated and the detected values are reflected in a control system, the case where performance of a magnet is measured, and similar case.

During taking these measurements, it is required that the structure is as simple as possible and a high accurate measurement is taken.

Japanese Unexamined Patent Application No. 2008-39626 (see FIGS. 1 and 3) discloses disposing a capacitively-coupled pressure sensor and a crystal unit arranged in a space isolated from a region where the pressure sensor is arranged. A variable capacitor of the pressure sensor and the crystal unit are connected in parallel. Change in capacitance of the pressure sensor changes an anti-resonance point of the crystal unit so as to detect a pressure.

The principles disclosed in Japanese Unexamined Patent Application No. 2006-138852 and Japanese Unexamined Patent Application No. 2008-39626 are completely different from that of the present disclosure.

The present disclosure is made under such a background, and provides an external force detection equipment and an external force detection sensor that can detect an external force applied to a piezoelectric plate with a simple structure and high accuracy.

### SUMMARY

The present disclosure provides an external force detection equipment for detecting an external force acting on a piezoelectric plate. The external force detection equipment includes a container, a supporting portion, one excitation electrode, another excitation electrode, an oscillation circuit, a movable electrode, a fixed electrode, a frequency information detecting unit, and a conductor. The container includes an insulator. The supporting portion supports the piezoelectric plate in the container. The one excitation electrode and the another excitation electrode vibrate the piezoelectric plate. The one excitation electrode is disposed at one surface side of the piezoelectric plate. The another excitation electrode is disposed at another surface side of the piezoelectric plate. The oscillation circuit electrically connects to the one excitation electrode. The movable electrode forms a variable capacitor. The movable electrode is disposed in a position apart from the supporting portion of the piezoelectric plate. The movable electrode electrically connects to the another excitation electrode. The fixed electrode is disposed to face the movable electrode separately from the piezoelectric plate. The fixed electrode connects to the oscillation circuit. The fixed electrode disposed to face the movable electrode separately from the piezoelectric plate, the fixed electrode connecting to the oscillation circuit, the capacitance value between the movable electrode and the fixed electrode varying by bending of the piezoelectric plate. The frequency information detecting unit is for detecting a signal that is frequency information corresponding to an oscillation frequency of the oscillation circuit. The conductor is disposed at least one of a bent portion by an external force and a portion facing the bent portion. The bent portion is on a surface at an opposite side to the movable electrode in the piezoelectric plate. An oscillation loop is formed from the oscillation circuit to pass through the one excitation electrode, the another excitation electrode, the movable electrode, and the fixed electrode, and return to the oscillation circuit. The frequency information detected by the frequency information detecting unit is used for estimating an external force acting on the piezoelectric plate.

According to the external force detection equipment of the present disclosure, the piezoelectric plate may include: a main body portion where the movable electrode is formed; and a plurality of supporting joists along a peripheral direction of the main body portion. The respective supporting joists extend outward and being supported by the supporting portion.

Further, according to the external force detection equipment of the present disclosure, the one excitation electrode may be disposed on a surface at an opposite side of a surface where the movable electrode is formed in the piezoelectric plate, and the movable electrode may be used both as the another excitation electrode. A slit for easily bending the piezoelectric plate may be formed at the supporting joist

The present disclosure provides an external force detection sensor used for the external force detection equipment described above. The external force detection sensor includes a container, a supporting portion, one excitation electrode, another excitation electrode, a movable electrode, a fixed electrode, and a conductor. The container includes an insulator. The supporting portion supports the piezoelectric plate in the container. The one excitation electrode and the another excitation electrode vibrate the piezoelectric plate. The one excitation electrode is disposed at one surface side of the piezoelectric plate. The another excitation electrode is disposed at another surface side of the piezoelectric plate. The movable electrode forms a variable capacitor. The movable electrode is disposed in a position apart from the supporting portion of the piezoelectric plate. The movable electrode electrically connects to the another excitation electrode. The fixed electrode is disposed to face the movable electrode separately from the piezoelectric plate. The fixed electrode connects to the oscillation circuit. The fixed electrode forms a variable capacitor by changing capacitance between the movable electrode and the fixed electrode by bending of the piezoelectric plate. The conductor is disposed at east one of a portion bent by an external force and a portion facing the bent portion. The bent portion is on a surface at an opposite side to the movable electrode in the piezoelectric plate.

With the present disclosure, when an external force is applied to the piezoelectric plate and the piezoelectric plate is bent or the degree of bending is changed, a distance between the movable electrode at the piezoelectric plate side and the fixed electrode that faces the movable electrode is changed. This changes the capacitance between both the electrodes. This change in capacitance and the degree of bending of the piezoelectric plate are obtained as change in oscillation frequency of the piezoelectric plate. This allows detecting slight deformation of the piezoelectric plate as a change in oscillation frequency, thus measuring the external force applied to the piezoelectric plate with high accuracy with a simple configuration of the equipment.

The conductor is disposed in the bent portion when the external force is applied to the piezoelectric plate or in the portion at the container side facing this bent portion. This does not attract the piezoelectric plate to the container side by the electrostatic attractive force, thus ensuring stable measurement.

### BRIEF DESCRIPTION OF THE DRAWINGS

FIG. 1 is a longitudinal cross-sectional side view illustrating a main part of a first embodiment where external force detection equipment according to the present disclosure is applied as an acceleration detection apparatus.

FIGS. 2A and 2B are respective plan views illustrating a top surface and a bottom surface of a crystal unit used in the first embodiment.

FIG. 3 is a block diagram illustrating a circuit configuration of the acceleration detection apparatus.

FIG. 4 is a circuit diagram illustrating an equivalent circuit of the acceleration detection apparatus.

FIG. 5 is a characteristic diagram illustrating a relationship between acceleration and frequency difference that are obtained using the acceleration detection apparatus

FIG. 6 is a longitudinal cross-sectional side view illustrating an embodiment where the external force detection equipment according to the present disclosure is applied as an acceleration detection apparatus.

FIG. 7 is a cross-sectional plan view along the line A-A′ in FIG. 6.

FIG. 8 is a cross-sectional plan view along the line B-B′ in FIG. 6.

FIG. 9 is a plan view illustrating the back side of a crystal blank used in the embodiment.

FIG. 10 is a longitudinal side view illustrating a state where the crystal blank is bent by an external force and dimensions of respective portions in the embodiment.

FIG. 11 is an external appearance view illustrating an external appearance of a part of the acceleration detection apparatus according to the embodiment.

FIG. 12 is a block circuit diagram illustrating a circuit of the acceleration detection apparatus according to the embodiment.

FIG. 13 is a longitudinal cross-sectional side view illustrating a second embodiment where the external force detection equipment according to the present disclosure is applied as an acceleration detection apparatus.

FIG. 14 is a plan view illustrating the second embodiment where the external force detection equipment according to the present disclosure is applied as an acceleration detection apparatus.

FIG. 15 is a perspective view illustrating a crystal blank and a supporting portion of the crystal blank that are used in a third embodiment.

FIG. 16 is a longitudinal side view illustrating a state where the crystal blank is bent by an external force and dimensions of respective portions in the third embodiment.

### DETAILED DESCRIPTION

### FIRST EMBODIMENT

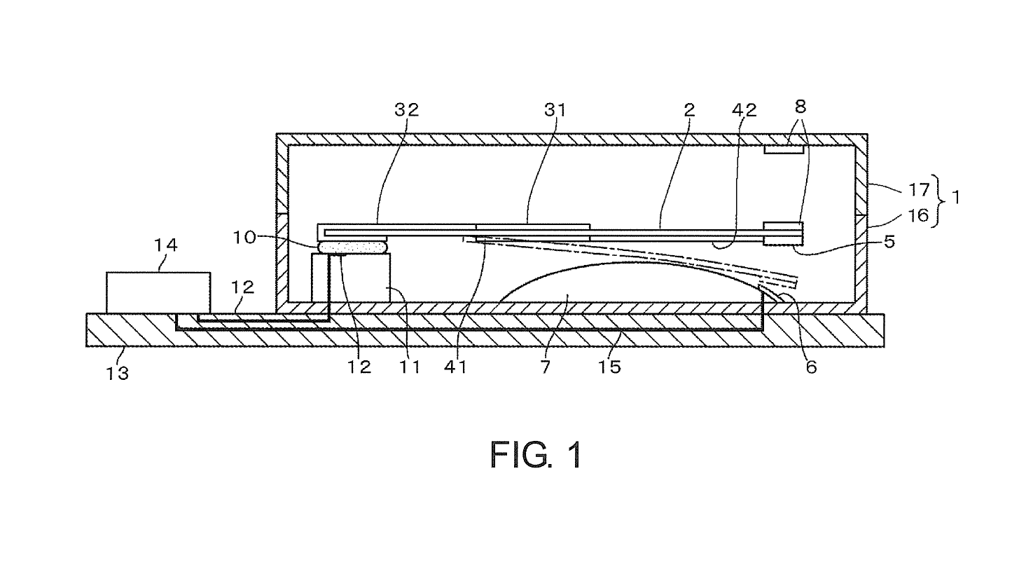

An example where the present disclosure is applied to an acceleration detection apparatus will be described. FIG. 1 is a view illustrating an acceleration sensor corresponding to an external force detection sensor that is a sensor portion of the acceleration detection apparatus. In FIG. 1, the reference numeral 1 denotes a rectangular parallelepiped-shaped sealed container made of, for example, crystal. The inside of the container is in a vacuum state. This container 1 is constituted of a base 16 and a lid portion 17 bonded to the base at the peripheral edge portion. The container 1 employs, for example, a ceramic such as glass or a crystal as a material. The container 1 is not necessarily limited to the sealed container. In the container 1, a pedestal 11 made of crystal is disposed. The pedestal 11 functions as a supporting portion that supports a crystal blank 2. One end side of the crystal blank 2 that is a piezoelectric plate is secured to the top surface of the pedestal 11, with a conductive adhesive 10. That is, the crystal blank 2 is cantilevered to the pedestal 11. The crystal blank 2 is, for example, a Z-cut crystal formed in a strip shape where a thickness is set to 0.03 mm for example. Accordingly, a distal end portion of the crystal blank 2 is bent by applying a force in a direction intersecting with the crystal blank 2.

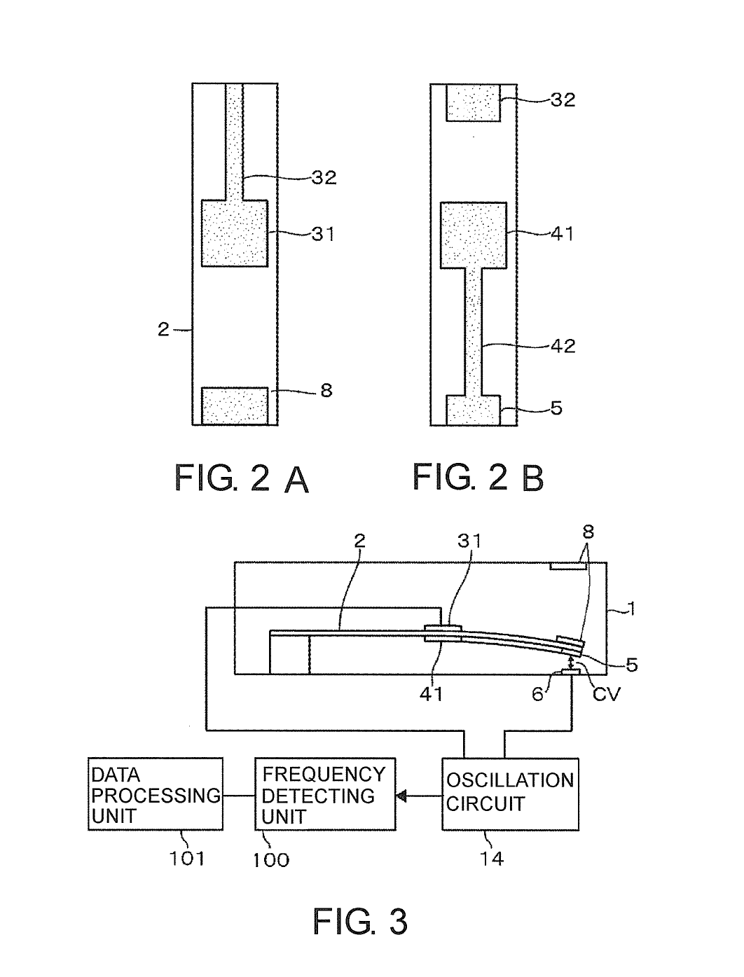

In the crystal blank 2, as illustrated in FIG. 2A, one excitation electrode 31 is disposed at the center of the top surface. As illustrated in FIG. 2B, another excitation electrode 41 is disposed in a portion corresponding to the excitation electrode 31 on the bottom surface. The excitation electrode 31 at the top surface side connects to a strip-shaped extraction electrode 32. The extraction electrode 32 is bent back onto the bottom surface side at the one end side of the crystal blank 2.

On the top surface of the pedestal 11, a conductive path 12 made of a metal film is formed. This conductive path 12 passes through the container 1, and connects to one end of an oscillation circuit 14 disposed on an insulating substrate 13 supporting the container 1.

The excitation electrode 41 at the bottom surface side connects to a strip-shaped extraction electrode 42. The extraction electrode 42 is extracted to the other end side (the distal end side) of the crystal blank 2, and connects to a movable electrode 5 that forms a variable capacitor. On the bottom portion of the container 1, a protrusion 7 formed of a convex-shaped crystal is disposed. The protrusion 7 has a square shape as seen in a plan view. When a longitudinal direction of the crystal blank 2 is assumed to be a front-back direction, the top surface of the protrusion 7 forms a curved line that bulges upward in a cross section viewed from a right-left direction. That is, in the protrusion 7, the top surface is bent in an arc shape that protrudes toward the crystal blank 2 side along the longitudinal direction of the crystal blank 2. The protrusion 7 is constituted such that a base end side with respect to the distal end portion of the crystal blank 2 collides with the protrusion 7, when the crystal blank 2 excessively bent to the protrusion 7 side. In a position facing the movable electrode 5 on the protrusion 7, a fixed electrode 6 that forms the variable capacitor with the movable electrode 5 is disposed.

On the top surface side of the distal end portion of the crystal blank 2, a metal film that is a conductor 8 is disposed in a position corresponding to the movable electrode 5 by, for example, sputtering Au. On the bottom surface of the lid portion 17, another conductor 8 made of the metal film is formed also in an area where the conductor 8 described above is projected in a horizontal posture of the distal end portion of the crystal blank 2.

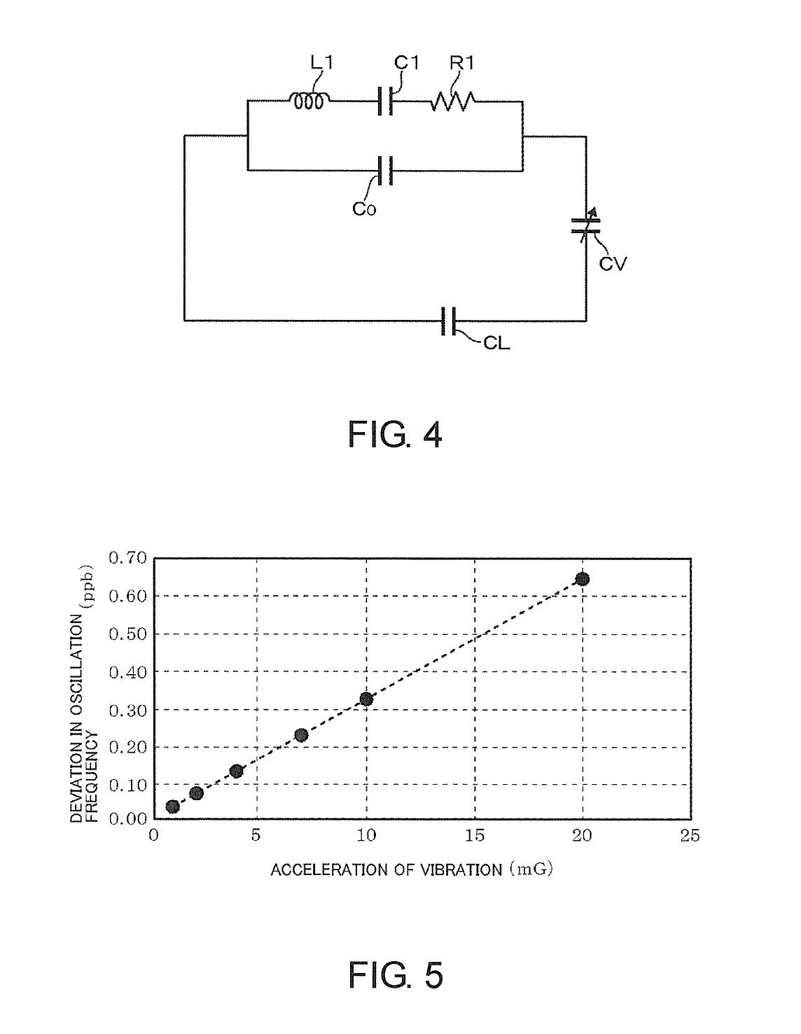

The fixed electrode 6 connects to the other end side of the oscillation circuit 14 via an extraction electrode 15 that is wired via the insulating substrate 13. FIG. 3 illustrates a connection state of wiring of the external force detection sensor. FIG. 4 illustrates an equivalent circuit that shows a connection state. The reference symbol L1 denotes a motional inductance corresponding to the mass of the crystal unit, the reference symbol C1 denotes a motional capacitance, the reference symbol R1 denotes a motional resistance, the reference symbol C0 denotes an effective shunt capacitance including inter-electrode capacitance, and the reference symbol CL denotes a load capacitance of the oscillation circuit. The excitation electrode 31 at the top surface side and the excitation electrode 41 at the bottom surface side connect to the oscillation circuit 14. Between the excitation electrode 41 at the bottom surface side and the oscillation circuit 14, a variable capacitor Cv formed between the movable electrode 5 and the fixed electrode 6 is interposed.

The weight of the distal end portion of the crystal blank 2 may be increased so as to increase a bending amount during application of a force. For example, the thickness of the movable electrode 5 may be increased. A weight may be mounted at the bottom surface side or the top surface side of the distal end portion of the crystal blank 2.

Here, according to the international standard IEC 60122-1, a general formula of the crystal oscillation circuit is represented as following formula (1).

FL=Fr×(1+x)

x=(C1/2)×1/(C0+CL) (1)

FL is an oscillation frequency when a load is applied to the crystal unit, and Fr is a resonance frequency of the crystal unit itself.

In this embodiment, as illustrated in FIG. 3 and FIG. 4, load capacitance of the crystal blank 2 is the sum of CL and Cv. Therefore, y represented by formula (2) is substituted for CL in formula (1).

y=1/(1/Cv+1/CL) (2)

Therefore, assume that a bending amount of the crystal blank 2 changes from State 1 to State 2 so as to change the variable capacitor Cv from Cv1 to Cv2. A change dFL in frequency is represented by formula (3).

dFL=FL1−FL2=A×CL²×(Cv2−Cv1)/(B×C) (3)

Here,

A=C1×Fr/2

B=C0×CL+(C0+CL)×Cv1

C=C0×CL+(C0+CL)×Cv2

When no acceleration is applied to the crystal blank 2, so to speak, in a reference state, a separation distance between the movable electrode 5 and the fixed electrode 6 is assumed to be d1. The separation distance when an acceleration is applied to the crystal blank 2 is assumed to be d2. Then, the following formula (4) is satisfied.

Cv1=S×ε/d1

Cv2=S×ε/d2 (4)

However, S is an area of a facing region of the movable electrode 5 and the fixed electrode 6, and ε is a relative dielectric constant.

Since d1 is already known, it can be seen that dFL and d2 are in correlation.

The acceleration sensor as a sensor portion of this embodiment is in a state where the crystal blank 2 is slightly bent even in a state where no external force corresponding to an acceleration is applied. Here, whether the crystal blank 2 is in a bent state or kept in a horizontal state is determined depending on the thickness of the crystal blank 2 or similar parameter.

The acceleration sensor in this configuration is used as, for example, an acceleration sensor for detecting lateral vibrations and an acceleration sensor for detecting longitudinal vibrations. The former is mounted such that the crystal blank 2 becomes vertical, and the latter is mounted such that the crystal blank 2 becomes horizontal.

For example, when an earthquake occurs or simulation vibrations are applied, a downward force is applied to the distal end portion of the crystal blank 2. Then, the crystal blank 2 is bent as illustrated by chain lines in FIG. 1 or as illustrated by solid lines in FIG. 3. Frequency information detected by a frequency detecting unit 100 in a state where no load of the external force is applied and the crystal blank 2 is not bent is assumed to be FL1. Frequency information to be detected in the case where the crystal blank 2 is bent by application of the external force is assumed to be FL2. The difference in frequency FL1−FL2 is represented by formula (3). The present inventors investigated a relationship between the ratio (FL1−FL2)/FL1 and the acceleration, and obtained the relationship illustrated in FIG. 5. Therefore, this proves that acceleration is obtained by measuring the difference in frequency.

In FIG. 3, the reference numeral 101 denotes a data processing unit constituted of, for example, a personal computer. The data processing unit 101 has a function to: obtain a difference between a frequency f0 when an external force is not applied to the crystal blank 2, and a frequency f1 when an external force is applied to the crystal blank 2, based on frequency information, for example, a frequency obtained from the frequency detecting unit 100; obtain a difference between these frequencies; and refers a table indicating the correspondence relationship of the frequency differences and the applied external forces so as to obtain the external force applied to the crystal blank 2. The frequency information is not limited to the frequency difference, and may be the change rate [(f1−f0)/f0] of frequency that is information corresponding to the difference in frequency.

With the first embodiment, when an external force is applied to the crystal blank 2 and the crystal blank 2 is bent or the degree of bending is changed, a distance between the movable electrode 5 at the crystal blank 2 side and the fixed electrode 6 that faces the movable electrode 5 is changed. This changes the capacitance between the movable electrode 5 and the fixed electrode 6. This change in capacitance changes the oscillation frequency in addition to the change in oscillation frequency by bending of the crystal blank 2. This allows detecting slight deformation of the crystal blank 2 as a change in oscillation frequency, thus measuring the external force applied to the crystal blank 2 with high accuracy.

Flexure of the crystal blank 2 generates static electrical charges at the crystal blank 2. Then, electrostatic induction produces electrical charges also on the bottom surface of the lid portion 17 that is an insulator facing the crystal blank 2. The crystal blank 2 and the lid portion 17 may be attracted to each other by an electrostatic attractive force. In this case, the relationship between the bending amount of the crystal blank 2 and the external force may become inaccurate or the top surface of the distal end portion of the crystal blank 2 may be stuck to the lid portion 17 so that the measurement cannot be taken. In the embodiment of the present disclosure, the conductive bodies 8 are disposed in both the top surface portion of the distal end portion of the crystal blank 2 where a variation amount in the height position is large when the external force is applied to the crystal blank 2 and a position facing the distal end portion of the crystal blank 2 in the lid portion 17. The region with the conductor 8 does not become polarized, thus reducing the electrostatic attractive force. Therefore, this avoids a phenomenon where the top surface of the distal end portion of the crystal blank 2 and the lid portion 17 are attracted to each other by the electrostatic attractive force or a phenomenon where the crystal blank 2 is stuck to the lid portion 17.

With the above-described embodiment, when an external force is applied to the crystal blank 2 and the crystal blank 2 is bent or the degree of bending is changed, a distance between the movable electrode 5 at the crystal blank 2 side and the fixed electrode 6 that faces the movable electrode 5 changes. This changes the capacitance between the electrodes 5 and 6. This change in capacitance and the degree of bending of the piezoelectric plate are obtained as a change in oscillation frequency of the piezoelectric plate. As a result, this allows measurement of the external force applied to the piezoelectric plate with high accuracy with a simple configuration of the equipment.

The conductor is disposed in a bent portion when the external force is applied to the crystal blank 2 or in a portion at the container side facing this bent portion. This does not attract the crystal blank 2 to the container 1 side by the electrostatic attractive force, thus ensuring a stable measurement.

The conductor 8 may be disposed at both the crystal blank 2 and the container 1 facing the crystal blank 2 like the above-described embodiment, and may be disposed at only one of these members to obtain a similar effect. The conductor 8 at the container 1 side or the conductor 8 at the crystal blank 2 side may connect to the earth so as to have the ground potential.

### SECOND EMBODIMENT

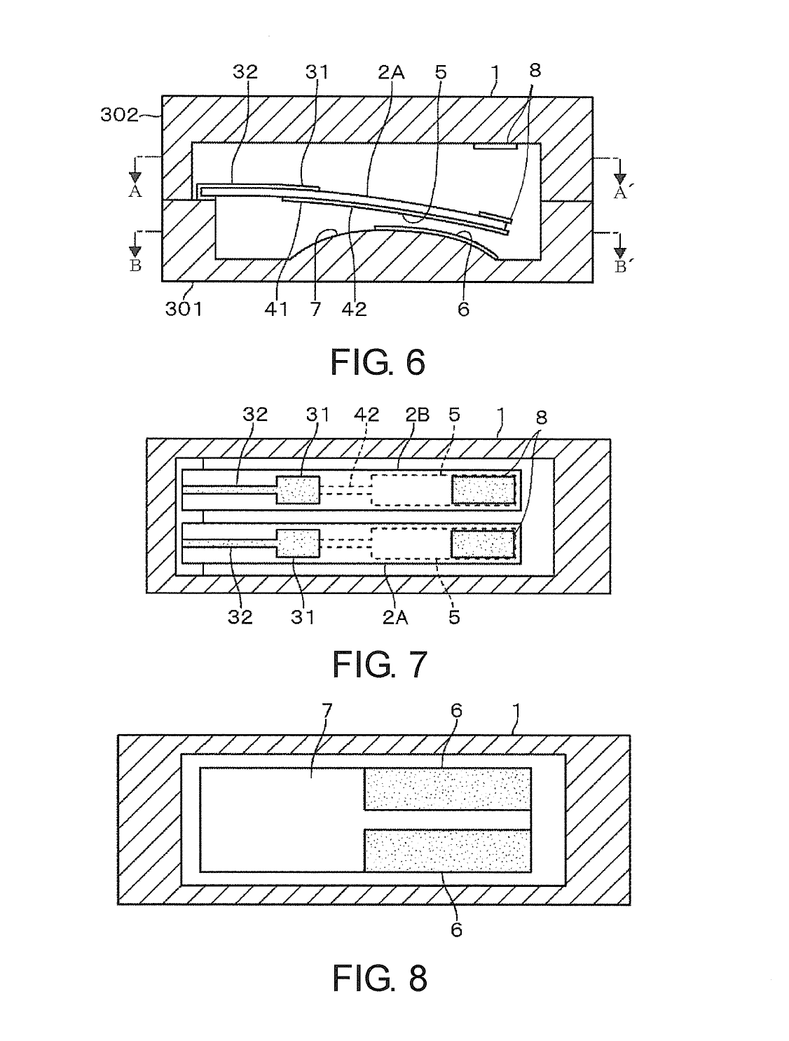

Next, a second embodiment where the present disclosure is applied to an acceleration sensor will be described with reference to FIG. 6 to FIG. 12. The second embodiment differs from the first embodiment in that two combinations of the crystal blank 2, the excitation electrodes 31 and 41, the movable electrode 5, the fixed electrode 6, and the oscillation circuit 14 are disposed. The reference numeral 301 is a bottom portion forming the base that constitutes the bottom side of the container 1. The reference numeral 302 is a top portion forming the lid body that constitutes the top side of the container 1. Regarding the crystal blank 2 and the oscillation circuit 14, the symbol “A” is added to parts of one combination, and the symbol “B” is added to parts of the other combination. In FIG. 6, the crystal blank 2 at one side is illustrated, and the view seen from a side surface is the same as FIG. 1. When the inside of the acceleration sensor of FIG. 6 is seen in a plan view, a first crystal blank 2A and a second crystal blank 2B are laterally disposed in parallel as illustrated in FIG. 7.

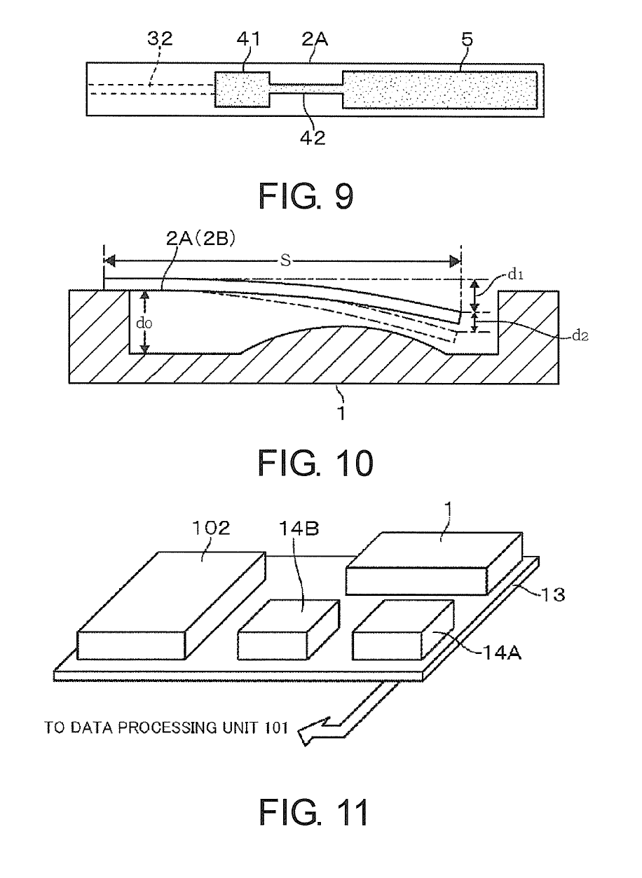

Since the crystal blanks 2A and 2B have the same structure, the one crystal blank 2A will be described. On one surface side (the top surface side) of the crystal blank 2A, the extraction electrode 32 with a narrow width extends from one end side toward the other end side. On the distal end portion of the extraction electrode 32, one excitation electrode 31 is formed in a square shape. Then, at the other surface side (the bottom surface side) of the crystal blank 2A, the other excitation electrode 41 is formed corresponding to the one excitation electrode 31 as illustrated in FIG. 7 and FIG. 9. At the excitation electrode 41 side, the extraction electrode 42 with a narrow width extends toward the distal end side of the crystal blank 2A. Additionally, at the distal end side of the extraction electrode 42, the strip-shaped movable electrode 5 for forming a variable capacitor is fonned. These electrodes 31 and so on are formed of a conductive material such as a metal film. The conductive bodies 8 are disposed at the respective top surface sides of the distal end portions of the crystal blanks 2A and 2B. The conductor 8 is disposed also in a position facing the conductor 8 at the bottom surface side of the lid portion of the container 1.

In the bottom portion of the container 1, the protrusion 7 formed of a convex-shaped crystal is disposed similarly to FIG. 1. The protrusion 7 has a lateral width set to a size corresponding to arrangement of the two crystal blanks 2A and 2B. That is, the protrusion 7 is set to have a size including a projection region of the two crystal blanks 2A and 2B. As illustrated in FIG. 8 and FIG. 9, the protrusion 7 includes the respective strip-shaped fixed electrodes 6 corresponding to the movable electrode 5 of the crystal blank 2A and the movable electrode 5 of the crystal blank 2B. In FIG. 7, for example, since a high priority is given to ease of understanding the structure, the bent shape of the crystal blank 2A (2B) is not accurately illustrated. However, in the case where the crystal blank 2A (2B) is formed with dimensions described below, excessive vibration of the crystal blank 2A (2B) causes collision of a portion close to the center with respect to the distal end of the crystal blank 2A (2B) with the protrusion 7.

Regarding the crystal blank 2A (2B) and its peripheral portion, an example of dimensions of the respective portions will be described with reference to FIG. 10. A length dimension S and a width dimension of the crystal blank 2A (2B) are respectively 18 mm and 3 mm. A thickness of the crystal blank 2A (2B) is, for example, several μm. In the case where a support surface at the one end side of the crystal blank 2A (2B) is set parallel to the horizontal surface, the crystal blank 2A (2B) is bent under its own weight in an undisturbed state where no acceleration is applied. The bending amount d1 is, for example, about 150 μm. A depth d0 of a space of a depressed portion in the bottom portion of the container 1 is, for example, 175 μm. A height dimension of the protrusion 7 is, for example, about 55 μm to 60 μm. These dimensions are only examples.

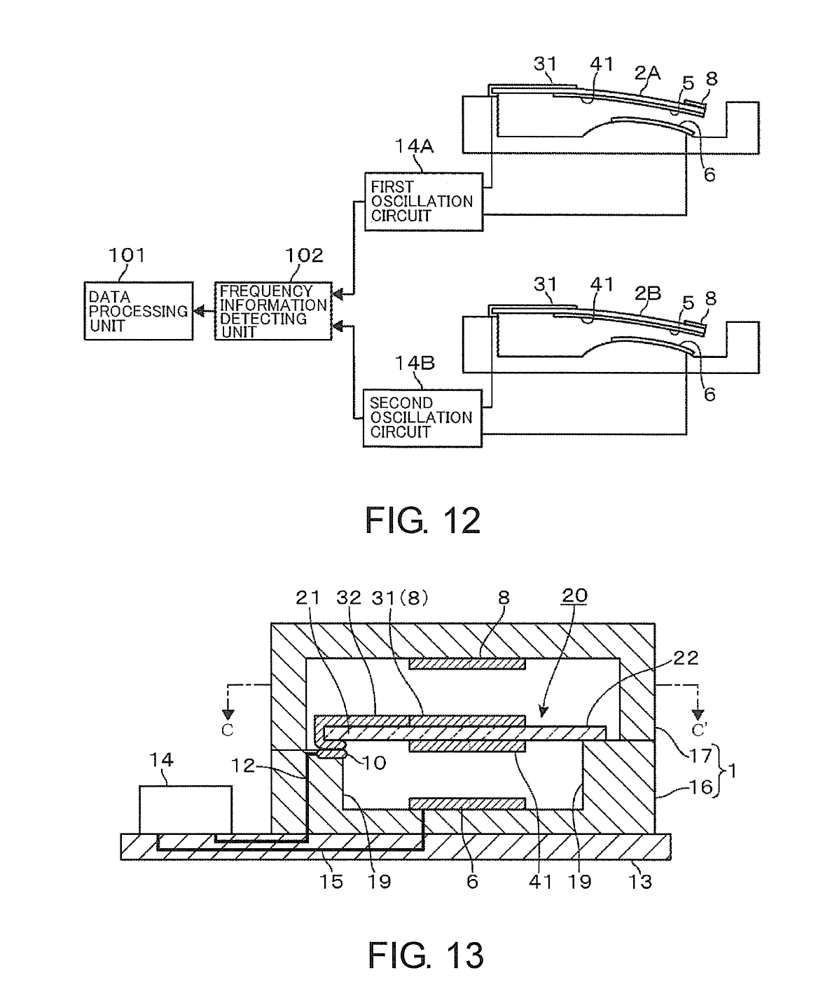

FIG. 11 illustrates a circuit of the acceleration detection apparatus of the second embodiment. FIG. 12 illustrates an external appearance of a part of the acceleration detection apparatus. A difference from the first embodiment is that a first oscillation circuit 14A and a second oscillation circuit 14B are connected respectively corresponding to the first crystal blank 2A and the second crystal blank 2B, and an oscillation loop including the oscillation circuit 14A (14B), the excitation electrodes 31 and 41, the movable electrode 5, and the fixed electrode 6 are formed for each of the first crystal blank 2A and the second crystal blank 2B. Outputs from the oscillation circuits 14A and 14B are transmitted to a frequency information detecting unit 102 where a difference in oscillation frequency or a difference in change rate of frequency from the respective oscillation circuits 14A and 14B is detected.

The change rate of frequency has the following meaning. In the oscillation circuit 14A, a frequency in the reference state where the crystal blank 2A is bent by its own weight is assumed to be the reference frequency. The change rate of frequency is a value represented by the change amount of frequency/the reference frequency when the crystal blank 2A is further bent by acceleration such that the frequency is changed, and represented in unit of ppb for example. Similarly, the change rate of frequency is calculated regarding the crystal blank 2B. A difference in change rate is output to the data processing unit 101 as information corresponding to frequency. In the data processing unit 101, a memory stores data where, for example, the difference between the change rates and the magnitude of acceleration are associated with each other so as to detect the acceleration based on this data and the difference between the change rates.

In an example of the relationship between a bending amount (difference in height level of the distal end portion between the case where the crystal blank 2A (2B) extends straight and the case where the crystal blank 2A (2B) is bent) of the crystal blank 2A (2B) and a change amount of frequency, for example, the distal end of the crystal blank 2A (2B) changes by the order of 10⁻⁵ μm. In the case where the oscillation frequency is 70 MHz, the change in frequency is 0.65 ppb. Therefore, even an extremely small external force, for example, an acceleration can be detected accurately.

According to the second embodiment, the crystal blank 2A and the crystal blank 2B are disposed in the same temperature environment. Therefore, even when respective frequencies of the crystal blank 2A and the crystal blank 2B are changed by the temperature, this change amount is cancelled. As a result, only a change amount of frequency based on bending of the crystal blanks 2A and 2B can be detected. This provides an effect of high detection accuracy.

The acceleration sensor according to the embodiment of the present disclosure may be constituted such that the excitation electrodes 31 and 41 are formed at the distal end side of the crystal blank 2A (2B) and the excitation electrode 41 at the bottom surface side is used both as the movable electrode 5. The excitation electrode 31 at the top surface side functions as the conductor 8 that prevents the crystal blank 2A (2B) from being charged.

### THIRD EMBODIMENT

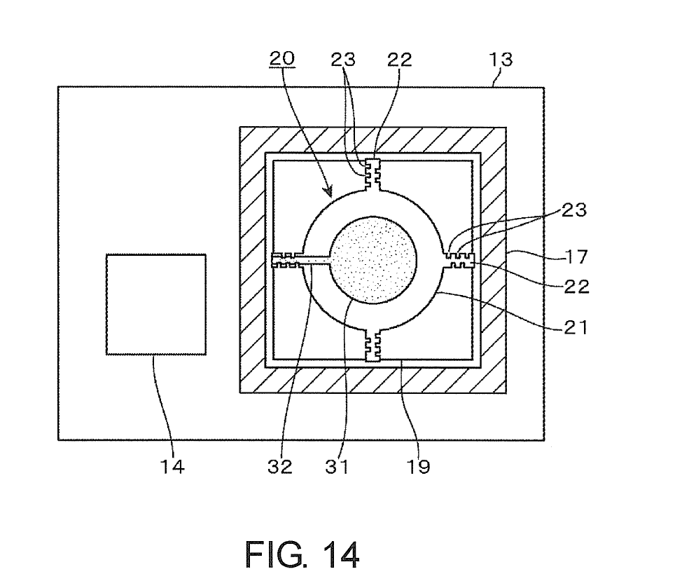

The external force detection equipment according to a third embodiment may be supported by a plurality of portions instead of the cantilevered configuration. As an example of this configuration, a circular plate-shaped crystal blank 20 may be supported by four directions inside of a rectangular parallelepiped-shaped container 1 using, for example, a ceramic such as glass as a material. FIG. 13 illustrates a longitudinal cross-sectional side view of the external force detection equipment according to the third embodiment. FIG. 14 illustrates a plan view taken along the line C-C′ in the external force detection equipment illustrated in FIG. 13.

For example, the container 1 includes the base 16 and the lid portion 17. The base 16 is formed in a box type shape with the open top portion. Pedestals 19 as a supporting portion are disposed at the entire periphery along an inner peripheral surface of a side surface portion. The base 16 is formed in a rectangular ring shape in a top view. As described below, the crystal blank 20 is mounted on the pedestal 19. Subsequently, the opening portion of the base 16 is covered with the lid portion 17 to form the sealed container 1. On the top surface of one pedestal 19 among the pedestals 19 disposed in the four directions, the conductive path 12 is disposed in a position where the crystal blank 20 is to be secured. The conductive path 12 leads to the outside passing through the container 1. The conductive path 12 connects to one end of the oscillation circuit 14 disposed on the insulating substrate 13 supporting the container 1.

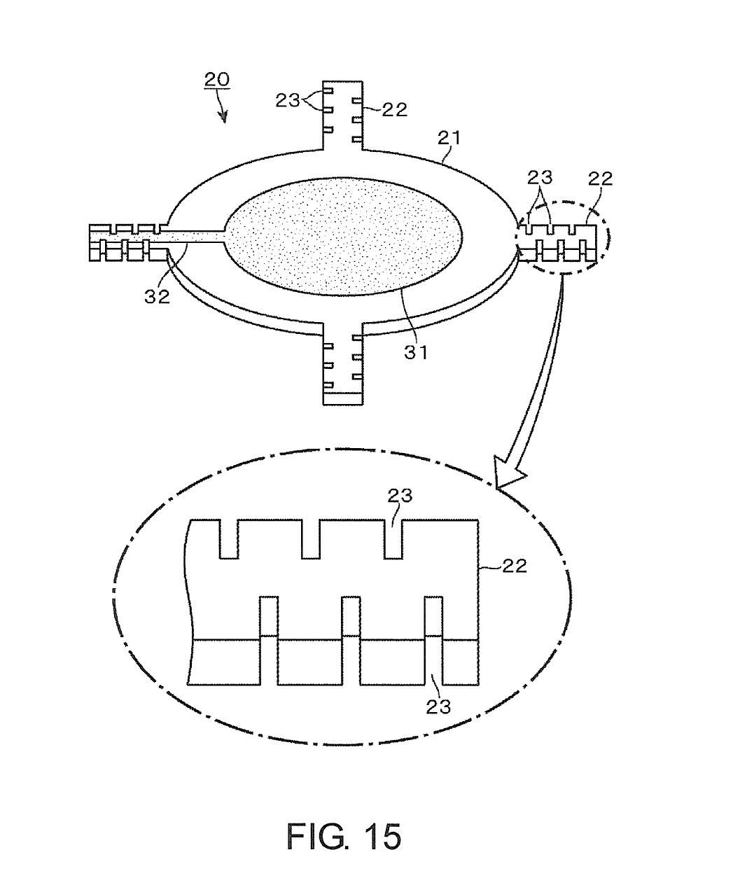

The crystal blank 20 is constituted of a circular plate portion 21 and supporting joists 22. The circular plate portion 21 is formed by cutting from one crystal, functions as a main body portion where the excitation electrode is disposed, and has a diameter of 5 min and a thickness of 0.02 mm for example. The supporting joists 22 radially extend from four portions equally spaced in the circumferential direction of the circular plate portion 21. The supporting joist 22 is constituted in approximately a rectangular parallelepiped shape with a width of 0.3 mm. As illustrated in FIG. 15, the supporting joists 22 each include slits 23 that extend with a length of 0.05 mm from the side surface to the inside. The slits 23 are disposed alternately in portions at both right and left sides at an interval of 0.3 mm in the longitudinal direction of the supporting joist 22. The supporting joist 22 has a structure in what is called an accordion shape.

At the top surface side and the bottom surface side in the circular plate portion 21, the respective excitation electrodes 31 and 41 are disposed in circular shapes concentrically with the circular plate portion 21. The respective excitation electrodes 31 and 41 are arranged corresponding to each other via the circular plate portion 21. The excitation electrodes 31 and 41 each have a two-layer structure of for example, Cr and Au, and are each formed with a thickness of about 0.1 μm. From the excitation electrode 31 at the top surface side of the crystal blank 20, the strip-shaped extraction electrode 32 extends. The extraction electrode 32 extends in a direction of one of the supporting joist 22, is subsequently bent back at the distal end of the supporting joist 22, and leads to the bottom surface side of the supporting joist 22.

In the crystal blank 20, the respective distal end portions of the supporting joists 22 are secured with the conductive adhesive 10 on the top surface of the pedestal 19 along the internal surface of the base 16. Accordingly, the circular plate portion 21 is supported by the four supporting joists 22 in the container and has a posture horizontal to the bottom surface of the container 1. The extraction electrode 32 led to the bottom surface of the supporting joist 22 connects to the conductive path 12 disposed at the pedestal 19 via the conductive adhesive 10. Accordingly, the electrode at the top surface side of the crystal blank 20 connects to the one end side of the oscillation circuit 14.

On the bottom surface portion of the base 16 forming the container 1, the fixed electrode 6 is disposed in a position corresponding to the excitation electrode 41 disposed at the bottom surface side of the crystal blank 20 via a clearance. In the center portion at the bottom surface side of the lid portion 17, the conductor 8 is disposed in a position facing the excitation electrode 31 via a clearance. The fixed electrode 6 connects to the other end side of the oscillation circuit 14 via the extraction electrode 15 that is wired via the insulating substrate 13.

In the third embodiment, the excitation electrode 31 disposed on the top surface of the crystal blank 20 functions as one excitation electrode. The excitation electrode 41 disposed on the bottom surface functions as the other excitation electrode. Simultaneously, the excitation electrode 31 at the top surface side and the conductor 8 disposed on the bottom surface of the lid portion 17 each function as the conductor 8 that prevents attraction by an electrostatic attractive force generated by electrostatic charge of the crystal blank 20. The excitation electrode 41 disposed at the bottom surface side of the crystal blank 2 functions as a movable electrode that changes the capacitance, and constitutes a variable capacitor with the fixed electrode 6 disposed at the base.

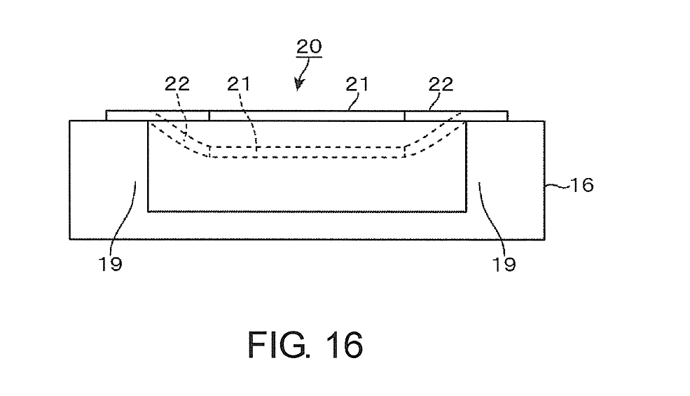

When an external force is applied to the external force detection equipment of the third embodiment, the center portion of the crystal blank 20 is bent as illustrated by dashed lines in FIG. 16. Then, the height position of the crystal blank 20 changes. This bending amount changes a distance between the excitation electrode 41 disposed in the center portion of the crystal blank 20 and the fixed electrode 6 so as to change the capacitance between both the electrodes 41 and 6. This change in capacitance and the deformation of the crystal blank 20 appear as a change in oscillation frequency of the crystal blank 20. Accordingly, the magnitude of the external force can be detected by the oscillation circuit. At the top surface side of the center portion of the crystal blank 20, the excitation electrode 31 is disposed. In the center portion at the bottom surface side of the lid portion 17 facing the excitation electrode 31, the conductor 8 is disposed. Therefore, the center portions at the top surface side of the crystal blank 20 and at the bottom surface side of the lid portion 17 are not charged. Thus, the static electrical charge due to the flexure of the crystal blank 20 does not occur, and also the electric charge due to the electrostatic induction on the bottom surface of the lid portion 17, which is an insulator facing the crystal blank 2, does not occur. Accordingly, the crystal blank 2 and the lid portion 17 are not attracted to each other by an electrostatic attractive force.

The structure of the supporting joist 22 may be constituted in an accordion shape where the slits 23 are disposed alternately at the top surface side and the bottom surface side. The number of the supporting joists 22 may be two, or equal to or more than three. Additionally, the main body portion may have a rectangular plate shape.

In the above description, the present disclosure is not limited to measurement of acceleration, and applicable to measurement of magnetic force, measurement of inclination degree of a measuring object, measurement of flow rate of fluid, measurement of wind speed, and similar measurement.

For example, as an example of the external force detection equipment, the configuration example in the case where a magnetic force is measured will be described. In the configuration of the crystal blank 2 or 20, a film of a magnetic material is formed in a portion between the movable electrode 5 and the excitation electrode 41. When the magnetic material is placed in a magnetic field, the crystal blank 2 or 20 is bent. The film of a magnetic material may be used both as the movable electrode 5 and the excitation electrode 41.

Additionally, the crystal blank 2 or 20 is exposed in fluid such as gas and liquid. A flow rate is detected with frequency information corresponding to a bending amount of the crystal blank 2 or 20. In this case, the thickness of the crystal blank 2 or 20 is determined based on a measuring range of the flow rate and similar parameter. Further, the present disclosure is applicable to the case where the gravity is measured.

What is claimed is:

1. An external force detection equipment for detecting an external force acting on a piezoelectric plate, the external force detection equipment comprising:
a container that includes an insulator;
a supporting portion that supports the piezoelectric plate in the container;
one excitation electrode and another excitation electrode to vibrate the piezoelectric plate, the one excitation electrode being disposed at one surface side of the piezoelectric plate, the another excitation electrode being disposed at another surface side of the piezoelectric plate;
an oscillation circuit electrically connecting to the one excitation electrode;
a movable electrode to form a variable capacitor, the movable electrode being disposed in a position apart from the supporting portion of the piezoelectric plate, the movable electrode electrically connecting to the another excitation electrode;
a fixed electrode disposed to face the movable electrode separately from the piezoelectric plate, the fixed electrode connecting to the oscillation circuit, the capacitance value between the movable electrode and the fixed electrode varying by bending of the piezoelectric plate;
a frequency information detecting unit for detecting a signal that is frequency information corresponding to an oscillation frequency of the oscillation circuit; and
a conductor disposed at least one of a portion bent by an external force and a portion facing the bent portion, the bent portion being on a surface at an opposite side to the movable electrode in the piezoelectric plate,
wherein an oscillation loop is formed from the oscillation circuit to pass through the one excitation electrode, the another excitation electrode, the movable electrode, and the fixed electrode, and return to the oscillation circuit, and
the frequency information detected by the frequency information detecting unit is used for estimating an external force acting on the piezoelectric plate.

2. The external force detection equipment according to claim 1,
the piezoelectric plate is formed in a strip shape and has one end side and another end side of a longitudinal direction, the one end side being supported by the supporting portion, and the another end side being a free end.

3. The external force detection equipment according to claim 1,
wherein the piezoelectric plate includes: a main body portion where the movable electrode is formed; and a plurality of supporting joists along a peripheral direction of the main body portion, the respective supporting joists extending outward and being supported by the supporting portion.

4. The external force detection equipment according to claim 3,
wherein the plurality of supporting joists includes two supporting joists that face one another toward the center portion of the the piezoelectric plate.

5. The external force detection equipment according to claim 3,
wherein a slit for easily bending the piezoelectric plate is formed at the supporting joist.

6. The external force detection equipment according to claim 5,
wherein the slits includes a slit cut from one edge and a slit cut from another edge, the another edge being an opposite edge of the one edge, the slit cut from one edge and the slit cut from the another edge being alternately disposed along a longitudinal direction of the supporting joist.

7. The external force detection equipment according to claim 3,
wherein the four supporting joists are arranged equally spaced in a circumferential direction.

8. The external force detection equipment according to claim 1,
wherein the one excitation electrode is disposed on a surface at an opposite side of a surface where the movable electrode is formed in the piezoelectric plate, and the movable electrode is used both as the another excitation electrode.

9. The external force detection equipment according to claim 1,
the conductor is grounded.

10. The external force detection equipment according to claim 1,
a magnetic material film is formed on the piezoelectric plate.

11. An external force detection sensor used for the external force detection equipment according to claim 1, the external force detection sensor comprising:
a container that includes an insulator;
a supporting portion that supports the piezoelectric plate in the container;
one excitation electrode and another excitation electrode to vibrate the piezoelectric plate, the one excitation electrode being disposed at one surface side of the piezoelectric plate, the another excitation electrode being disposed at another surface side of the piezoelectric plate;
a movable electrode to form a variable capacitor, the movable electrode being disposed in a position apart from the supporting portion of the piezoelectric plate, the movable electrode electrically connecting to the another excitation electrode;
a fixed electrode disposed to face the movable electrode separately from the piezoelectric plate, the fixed electrode connecting to the oscillation circuit, the fixed electrode forming a variable capacitor by changing capacitance between the movable electrode and the fixed electrode by bending of the piezoelectric plate; and
a conductor disposed at least one of a portion bent by an external force and a portion facing the bent portion, the bent portion being on a surface at an opposite side to the movable electrode in the piezoelectric plate.
